(19) United States
(12) Patent Application Publication
(10) Pub. No.: US 2020/0212542 A1
(43) Pub. Date: Jul. 2, 2020

(54) ANTENNA SYSTEM AND MOBILE TERMINAL

(71) Applicant: AAC Technologies Pte. Ltd., Singapore City (SG)

(72) Inventors: Zhengdong Yong, Shenzhen (CN); Zhimin Zhu, Shenzhen (CN); Chao Wang, Shenzhen (CN)

(21) Appl. No.: 16/702,566

(22) Filed: Dec. 4, 2019

(30) Foreign Application Priority Data
Dec. 31, 2018 (CN) 201811653398.3

(51) Int. Cl. H01Q 1/24; H01Q 9/04; H04M 1/02; H01Q 3/34

(52) U.S. Cl. CPC H01Q 1/243; H01Q 9/0407; H01Q 3/34; H01Q 9/045; H04M 1/0283

(57) ABSTRACT

The present disclosure provides an antenna system, which is applied to a mobile terminal. The mobile terminal includes a housing made of 3D glass or a ceramic material, and the housing includes a backplate and a sidewall connected to the backplate. The antenna system includes a LCP antenna attached to at least one of an inside surface of the backplate or an inside surface of the sidewall, and the LCP antenna includes antenna units arranged in an array sequentially in a same direction, and a phase shifter connected to the antenna units.

### TECHNICAL FIELD

The present disclosure relates to the field of antenna technologies, and in particular, to an antenna system and a mobile terminal.

### BACKGROUND

With 5G being the focus of research and development in the global industry, developing 5G technologies and formulating 5G standards have become the industry consensus. The ITU-RWP5D 22nd meeting held in June 2015 by International Telecommunication Union (ITU) identified three main application scenarios for 5G: enhance mobile broadband, large-scale machine communication, and highly reliable low-latency communication. These three application scenarios correspond to different key indicators, and in the scenario of the enhance mobile broadband, the user peak speed is 20 Gbps and the minimum user experience rate is 100 Mbps. 3GPP is working on standardization of 5G technology. The first 5G Non-Stand Alone (NSA) international standard was officially completed and frozen in December 2017, and the 5G Stand Alone standard was scheduled to be completed in June 2018. Research work on many key technologies and system architectures during the 3GPP conference was quickly focused, including the millimeter wave technology. The high carrier frequency and large bandwidth characteristics unique to the millimeter wave are the main means to achieve 5G ultra-high data transmission rates.

The rich bandwidth resources of the millimeter wave band provide a guarantee for high-speed transmission rates. However, due to the severe spatial loss of electromagnetic waves in this frequency band, wireless communication systems using the millimeter wave band adopts an architecture of a phased array. Phases of array elements distribute according to a regularity by a phase shifter, so that a high gain beam is formed and the beam scans in one spatial range through changing a phase shift.

3GPP stipulates that a bandwidth of the millimeter wave n257band ranges from 26.5 GHz to 29.5 GHz. There is a large challenge in an antenna design in which impedance matching is implemented at a bandwidth of 3 GHz with a housing of a high dielectric constant housing (e.g., a 3D glass housing, or a ceramic housing). In the related art, a method to implement the impedance matching is slot coupling feed using laminated patches, or extending a bandwidth of the antenna through increasing a thickness of a dielectric substrate.

Housings with high dielectric constants, such as a dielectric constant of the 3D glass or a dielectric constant of a ceramic, is a mainstream solution for a structure design of future phones with a full screen, which can provide better protection, aesthetics, thermal diffusion, chroma and user experience. However, a higher dielectric constant will seriously affect a radiation performance of the millimeter wave antenna and reduce the antenna array gain, and so on.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded perspective view of a mobile terminal;

FIG. 2 is a schematic diagram of a layout of a LCP antenna in the mobile terminal shown in FIG. 1;

FIG. 3 is a schematic diagram of an LCP antenna in a mobile terminal;

FIG. 4 is a plane schematic diagram of a first antenna unit;

FIG. 5 is a plane schematic diagram of a second antenna unit;

FIG. 6 is a diagram showing a reflection coefficient of a LCP antenna;

FIG. 7 is a diagram showing a total efficiency of a LCP antenna;

FIG. 8 is a diagram showing a reflection coefficient of a LCP antenna in a mobile terminal;

FIG. 9 is a simulation diagram of a radiation direction when a scanning angle of a LCP antenna is 0°;

FIG. 10 is a simulation diagram of a radiation direction when a scanning angle of a LCP antenna is 45°; and

FIG. 11 is a graph showing a gain CDF of a LCP antenna.

### DESCRIPTION OF EMBODIMENTS

The present disclosure will be further illustrated with reference to the accompanying drawings and the embodiments.

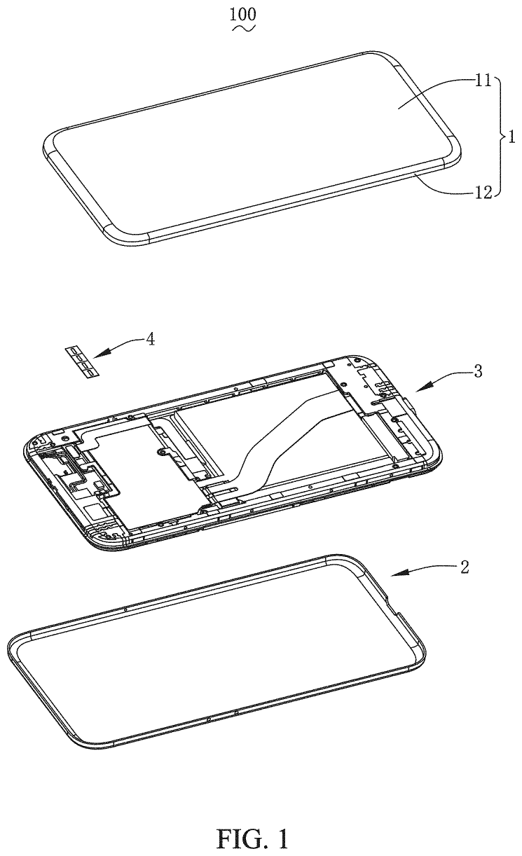

Referring to FIG. 1, an embodiment of the present disclosure provides an antenna system applied to a mobile terminal 100. The mobile terminal 100 includes a housing 1 made of three-dimensional (3D) glass or a ceramic material. The housing 1 includes a backplate 11 and a sidewall 12 connected to the backplate 11. Optionally, the mobile terminal 100 further includes a display screen 2 that is assembled with the housing 1 to form an accommodating space, other electronic elements 3 accommodated in the accommodating space, and a liquid crystal polymer (LCP) antenna 4 attached to at least one of an inside surface of the backplate 11 or an inside surface of the sidewall 12.

In an optional embodiment of the present disclosure, the housing 1 is made of 3D glass or the ceramic material, and has a dielectric constant greater than 10, which can provide better protection, aesthetics, thermal diffusion, chroma and user experience to the mobile terminal 100.

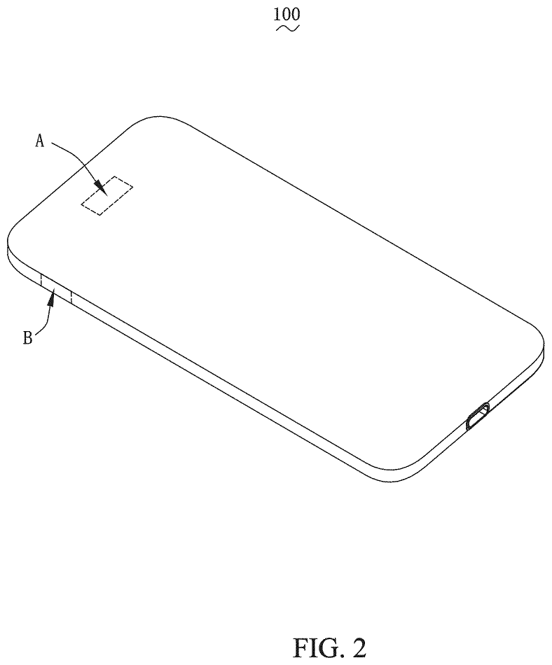

As shown in FIG. 2, the LCP antenna 4 can be attached to an inside surface of the backplate 11 (i.e., at an A position), or an inside surface of the sidewall 12 (i.e., a B position). Optionally, the LCP antennas 4 can be provided on both the inside surface of the backplate 11 and the inside surface of the sidewall 12. In an embodiment, the LCP antennas 4 are provided on both the inside surface of the backplate 11 and the inside surface of the sidewall 12.

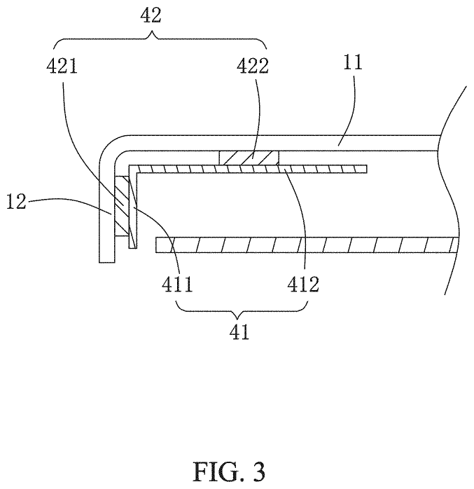

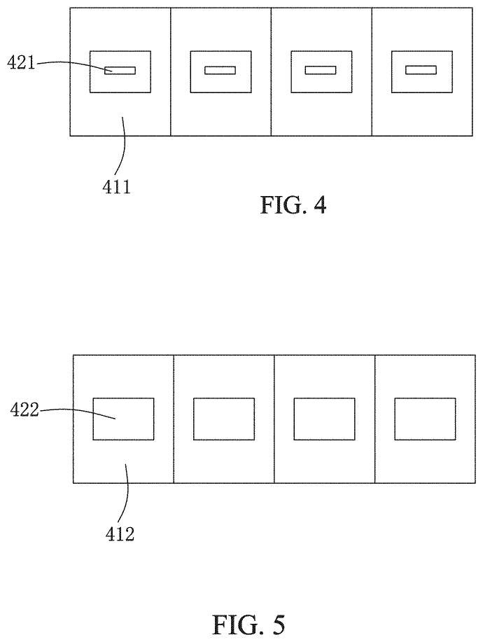

Referring to FIGS. 3-5 in conjunction, the LCP antenna 4 includes a LCP substrate layer 41, multiple antenna units 42 provided on the LCP substrate layer 41 and arranged in an array sequentially in a same direction, a phase shifter (not shown) connected to the multiple antenna units 42, and a radio frequency (not shown) front-end module electrically connected to the antenna unit 42. Optionally, the LCP substrate layer 41 has a thickness smaller than 50 um. Optionally, the antenna unit 42 is arranged on a side of the LCP substrate layer 41 facing the housing 1, and the radio frequency front-end module is arranged on a side of the LCP substrate layer 41 facing away from the housing 1. Optionally, the radio frequency front-end module can be encapsulated on the LCP substrate layer 41 by using a radio frequency front-end (RFFE) process.

Optionally, the LCP substrate layer 41 includes a first portion 411 attached to the sidewall 12 and a second portion 412 attached to the backplate 11. The antenna unit 42 includes a first antenna unit 421 interposed between the sidewall 12 and the first portion 411 and a second antenna unit 422 interposed between the backplate 11 and the second portion 412. The radio frequency front-end module is arranged on at least one of a side of the first portion 411 facing away from the sidewall 12 or a side of the second portion 412 facing away from the backplate 11. Optionally, the first antenna unit 421 is a slot antenna, and the second antenna unit 422 is a patch antenna. Optionally, the first antenna unit 421 is fed through a microstrip line.

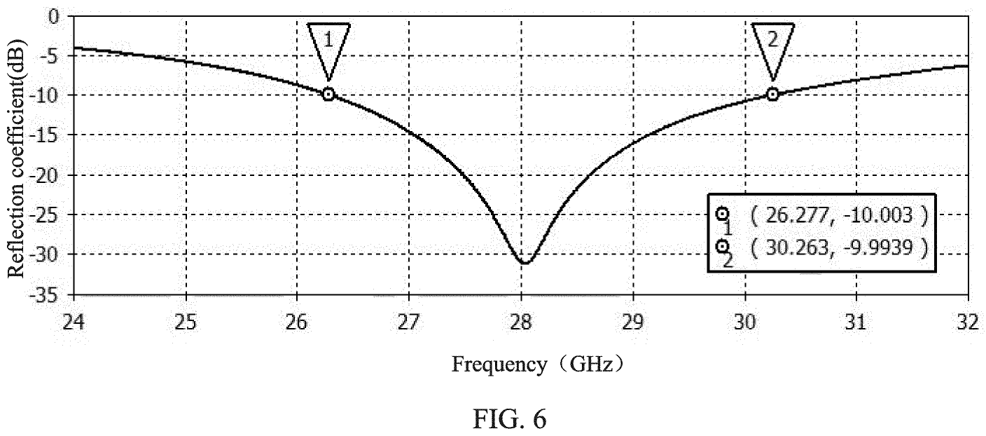

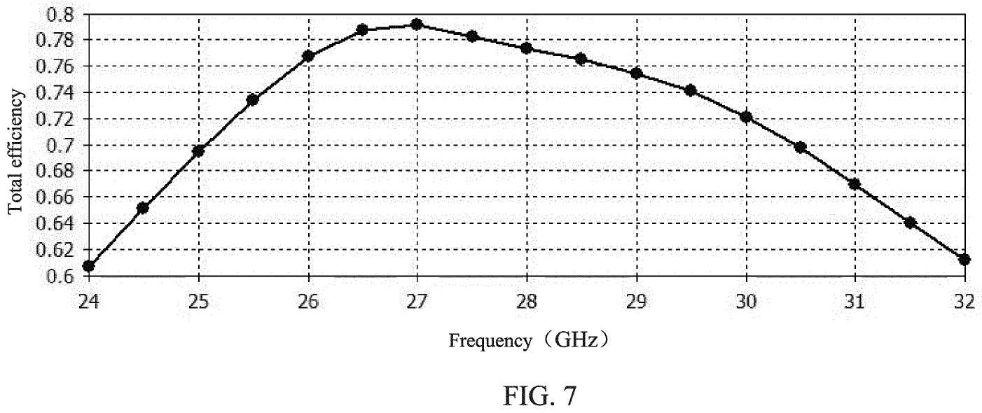

The LCP antenna 4 of a linear array composed of four antenna units 42 is attached to an inside of the housing 1 and its reflection coefficient and total efficiency are as shown in FIG. 6 and FIG. 7, respectively. The dielectric constant of the housing 1 is 10.2. It can be seen that an impedance bandwidth of the LCP antenna 4 in a frequency band of 26.3˜30.3 GHz reaches 4 GHz, and the reflection coefficient is smaller than −10 dB. The total efficiency in the 3GPP n267 band is above 74%, which basically meets an index requirement of 3GPP millimeter wave spatial coverage, and the impedance bandwidth of 4 GHz at 28 GHz can be achieved with only a 50 um thickness of the LCP antenna 4.

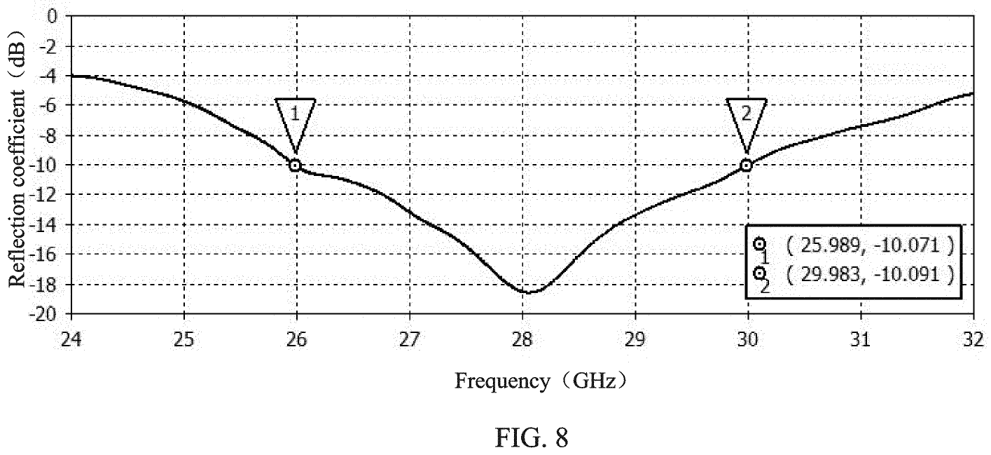

A performance of the LCP antenna 4 of the linear array composed of the four antenna units 42 in the mobile terminal 100 having the housing 1 is as shown in FIG. 8. It can be seen that the reflection coefficient corresponding to a range between a band of 26 GHz and a band of 30 GHz is also smaller than −10 dB.

The LCP antenna 4 adopts an architecture of the phased array. Through the phase shifter, phases of the antenna units 42 are distributed according to one regularity, which forms a high gain beam, and the beam scans in a spatial range by a changing a phase shift.

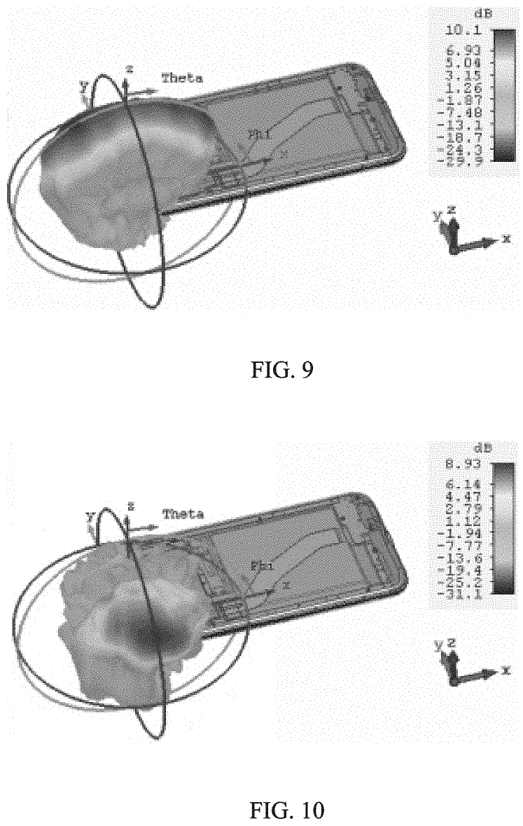

The case where the housing 1 is a 3D glass housing will be described in detail as an example. At the phase shifts of 0° and 45°, radiation directions of the LCP antenna 4 are shown in FIG. 9 and FIG. 10 respectively, and it can be seen that within the mobile terminal 100, the radiation direction of the LCP antenna 4 is not distorted.

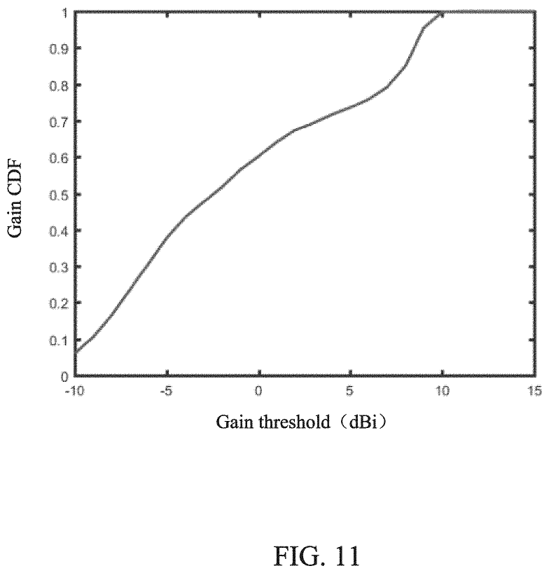

Referring to FIG. 11 in conjunction, a cumulative distribution function (CDF) is used to define a spatial coverage of the radio frequency terminal. A gain CDF is an integral of a probability density and defined as CDF(x)=P(Gain≤x), where Gain is a gain. It can be observed that in a case of 50% coverage, it is lowered by 10.9 dB compared with a peak gain, which meets the index requirement of the 3GPP millimeter wave spatial coverage.

The present disclosure further provides the mobile terminal 100, and the mobile terminal 100 includes the antenna system.

Compared with the related art, the antenna system provided by the present disclosure has following advantages:

1. the LCP antenna adopts the linear array, which simplifies design difficulty, test difficulty and complexity of beam management;

2. the LCP substrate layer is adopted in such a manner that it can be flexibly assembled in the mobile terminal, and the thickness is thin; and

3. the LCP antenna is applied to the housing made of the 3D glass or the ceramic material, which causes the gain reduction to be less and thereby an index requirement of the 3GPP millimeter wave spatial coverage to be met.

What has been described above is only an embodiment of the present disclosure, and it should be noted herein that one ordinary person skilled in the art can make improvements without departing from the inventive concept of the present disclosure, however, these improvements are all within the scope of the present disclosure.

What is claimed is:

1. An antenna system, applied to a mobile terminal, wherein the mobile terminal comprises a housing made of three-dimensional (3D) glass or a ceramic material, and the housing comprises a backplate and a sidewall connected to the backplate,
wherein the antenna system comprises:
a liquid crystal polymer (LCP) antenna attached to at least one of an inside surface of the backplate or an inside surface of the sidewall, wherein the LCP antenna comprises a plurality of antenna units arranged in an array sequentially in a same direction, and a phase shifter connected to the plurality of the antenna units.

2. The antenna system as described in claim 1, wherein the housing has a dielectric constant greater than 10.

3. The antenna system as described in claim 1, wherein the LCP antenna comprises a LCP substrate layer and a radio frequency front-end module, wherein the plurality of antenna units and the radio frequency front-end module are arranged on the LCP substrate layer, and the radio frequency front-end module is electrically connected to the plurality of antenna units.

4. The antenna system as described in claim 3, wherein the plurality of antenna units is arranged on a side of the LCP substrate layer facing the housing, and the radio frequency front-end module is arranged on a side of the LCP substrate layer facing away from the housing.

5. The antenna system as described in claim 3, wherein the radio frequency front-end module is encapsulated in the LCP substrate layer by an radio frequency front-end (RFFE) process.

6. The antenna system as described in claim 3, wherein the LCP substrate layer comprises a first portion attached to the sidewall and a second portion attached to the backplate, the plurality of antenna units comprises a first antenna unit interposed between the sidewall and the first portion and a second antenna unit interposed between the backplate and the second portion, and the radio frequency front-end module is arranged on at least one of a side of the first portion facing away from the sidewall or a side of the second portion facing away from the backplate.

7. The antenna system as described in claim 6, wherein the first antenna unit is a slot antenna, and the second antenna unit is a patch antenna.

8. The antenna system as described in claim 7, wherein the first antenna unit is fed by a microstrip line.

9. The antenna system as described in claim 3, wherein the LCP substrate layer has a thickness smaller than 50 um.

10. A mobile terminal, comprising the antenna system as described in claim 1.

11. A mobile terminal, comprising the antenna system as described in claim 2.

12. A mobile terminal, comprising the antenna system as described in claim 3.

13. A mobile terminal, comprising the antenna system as described in claim 4.

14. A mobile terminal, comprising the antenna system as described in claim 5.

15. A mobile terminal, comprising the antenna system as described in claim 6.

16. A mobile terminal, comprising the antenna system as described in claim 7.

17. A mobile terminal, comprising the antenna system as described in claim 8.

18. A mobile terminal, comprising the antenna system as described in claim 9.
